(19) United States
(12) Patent Application Publication
(10) Pub. No.: US 2003/0191717 A1
(43) Pub. Date: Oct. 9, 2003

(54) High performance server data delivery system and method

(76) Inventor: Teddy C. Johnson, Mountain View, CA (US)

Correspondence Address: HEWLETT-PACKARD COMPANY, Intellectual Property Administration, P. O. Box 272400, Fort Collins, CO, 80527-2400, US

(21) Appl. No.: 09/873,517

(22) Filed: Jun. 4, 2001

Related U.S. Application Data
(62) Division of application No. 09/092,488, filed on Jun. 5, 1998.

(51) Int. Cl. H04K 1/00; H04L 9/00; G06F 17/60; G06F 15/173

(52) U.S. Cl. 705/51; 709/225

(57) ABSTRACT

A secure, high-throughput, scalable apparatus and method of downloading software products and other data to authorized customers over the internet. A plurality of processes are run on different host machines. The machines communicate with each other via a secured link. This link uses DES encryption and an index to the DES keys, rather than passing the key itself over the link. Once derived, the indexed key is used for encryption and decryption over the communication link. File staging is accomplished by using a hard link between the file storage area and the customer account area. A customer account database is maintained on a secure machine as protected via a firewall. A secured link is also used through the firewall to securely allocate user access to file downloads.

### FIELD OF INVENTION

This invention relates to a secure, high-throughput, scalable apparatus and method of downloading software products and other data to authorized customers over the internet.

### BACKGROUND OF THE INVENTION

Presently software is sold and shipped via electronic and optical storage mediums such as floppy disks and compact disks. Such methods require physical duplication and shipment of new products to customers. This adds considerable expense, particularly when data products change or are updated periodically. In order to have current information, a user might need to frequently receive new software revisions.

Accordingly, the internet is fast becoming a preferred medium for information transfer, and new types of low cost equipment are continually being developed to connect users to the ever-growing number of websites. Access to a particular website is managed by a host server or router. External parties, or customers, typically contact the site via use of an internet browser to access a known URL (uniform resource locator). The website might be constructed so as to provide downloading access to programs or data, either on or through that host server, to customers contacting that site.

Prior configurations or solutions for downloading software from a website include possible drawbacks which affect the speed and security of the transfer. Security measures include firewalls which are hardware and/or software barriers which prevent access to certain isolated machines or programs within a network or system. Prior downloading configurations typically use one machine (or server), which is accessible externally to the firewall, which includes a web server, an ftp (file transport protocol) server, a database containing customer account information, a secured data repository, and customer download-areas. Prior configurations have typically chosen to download or deliver software from the same machine which is hosting the web server. Software can take a considerable time to prepare, or stage, for secure download to a customer, as the software is often physically copied from a secure area, on one side of a firewall, into a new area which is accessible by an external customer. The speed of such transfers is also affected by the requirement that the host server is often required to process too many tasks at the same time. Yet another time-consuming step might involve the requirement that customers be pre-configured on a certain database (external to the firewall) in order to access particular information.

In particular, a customer might typically use a web browser to access a well known URL, and then perform an authentication process using a username/password pair. The web browser might then backend script the information by invoking a cgi-bin (common gateway interface—binary) in order to check a customer account database to verify that the customer should be allowed access. The customer might then request a software download. The web server cgi-bin further checks the customer account in order to verify that the user is entitled to the particular requested software. Upon passing a validation check, the requested software is then copied from a secured file repository to a secured ftp account for this customer (e.g. secured via a Unix change root, or chroot, command). The web server then delivers an HTML (hypertext markup language) page to the customer's browser. When the user activates the ftp://URL on that page, the web browser communicates with the ftp server on that host, and the software download commences.

A primary drawback to this approach is that it severely slows down the web server performance, which typically displeases customers. Software files are generally very large (e.g. 10 to 100 Megabytes per download). During a software download, the web server's CPU cycles and network bandwidth must be shared with the ftp server. The ftp server uses considerable resources, as it must read the file from a disk storage area, and then send it out through a connection medium, for instance a LAN (local area network) card, to the client web browser.

Web server performance is further degraded because the standard method for making sure the customer only receives certain software (to which they are entitled) is generally very expensive to implement. One standard method is to create a custom change root ftp directory for the customer, and then to copy the software from a secure repository into that account. Under the preferred UNIX operating system, a chroot (change root) command achieves this objective. Methods involving symbolic links cannot be used, because symbolic links do not work in conjunction with a chroot command. The copying operation is extremely resource intensive, and gets more expensive in direct proportion to the size of the requested software object or file.

Another drawback of the prior solutions is that customers must be pre-configured into an external account database. The presents a synchronization problem in that the external database must contain customer information before the customer will be allowed access. The database also needs to be regularly updated to ensure that it contains the correct status of the customer account.

Hence, what is needed in the field is a solution for providing fast software delivery without impacting web server performance. This solution should also incorporate secure communications between host machines, fast file staging for software downloads, an dynamic user authentication through a firewall.

### SUMMARY OF THE INVENTION

The invention described herein provides a secure, high-throughput, scalable system and method of downloading software products and other data to authorized customers over the internet. The system uses separate machines for web server operations and ftp server operations in order to speed up performance. A secure mechanism for communicating between the two machines is used in order to properly stage the software for download. The secure mechanism utilizes a pair of client/server programs which use TCP (transmission control protocol), DES (data encryption standard), a filter to render the cipher string safe, and a secure method of passing DES keys.

A fast file staging mechanism is used to which enables software to be staged very quickly (e.g. less than one second), regardless of the size of the software object. Rather than physically copying software from a storage area to a staging area, a hard link is created between the customer's ftp account and the secure repository. The present invention also eliminates the need for an external customer account database via use of the secure commlink in conjunction with the tobj (tagged object) protocol. Tobj is a Hewlett-Packard SGML (standard Graphics Markup Language) style of data encapsulation protocol which implemented on top of standard protocols and which sends transactions across a specified range of ports. A master database of customer access information is maintained inside the firewall, with data crossing the firewall in a secure fashion.

Other advantages of this invention will become apparent from the following description taken in conjunction with the accompanying drawings which set forth, by way of illustration and example, certain embodiments of this invention. The drawings constitute a part of this specification and include exemplary embodiments, objects and features of the present invention.

### BRIEF DESCRIPTION OF THE DRAWINGS

FIG. 1 shows a prior art server configuration with the host machine running multiple processes external to a firewall.

FIG. 2 shows a server configuration of the present invention which separates processes onto multiple machines having a secure communication link (commlink) between them, uses fast file staging, and provides dynamic ftp authentication with a firewall protected customer database.

### DETAILED DESCRIPTION OF THE PREFERRED EMBODIMENT

The present invention provides a fast and secure method and system for downloading software, or other data, from a server configuration. The configuration separates processing tasks between machines to improve efficiency, yet maintains system control via a secure commlink between machines. File staging is provided via direct customer hard links to data storage areas and customer access is dynamically authenticated from a secure database.

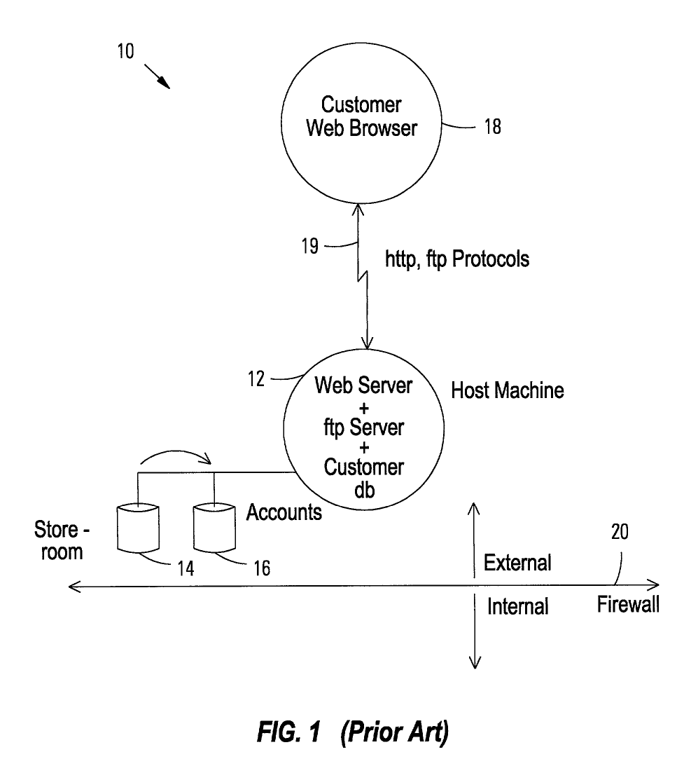

FIG. 1 shows a prior art configuration 10 which implements multiple processing tasks on one host machine 12. Such tasks might include, for instance, web server processes and ftp server processes. Also shown is a storeroom disk storage area 14 and a customer account disk storage area 16. When a customer desires a software download, the host machine 12 is contacted through connection 19 by the customer's web browser 18, via modem and the like, using hypertext transfer protocols (http). If a software download is desired by the customer, then the host machine authenticates a customer account through a customer database. The host machine then allocates space in the customer storage area 16 and requests copying of the desired software from the storeroom 14 to the relevant customer account area 16. When the copying operation is completed, the ftp server contained on the host machine 12 provides file transfer to the customer's web browser 18 via file transfer protocols (ftp).

This configuration results in a significant number of tasks being performed by one host machine 12, and over one customer/host connection 19. As a result, all of the host machine processes will be slowed down. Slower web processes result in customer access lags. Slower ftp processes result in longer file transfers. Limited bandwidth on the connection 19 results in bottle-necking of data being transferred to the customer web browser 18. Additionally, the server configuration 10 is located entirely outside of a protective firewall 20.

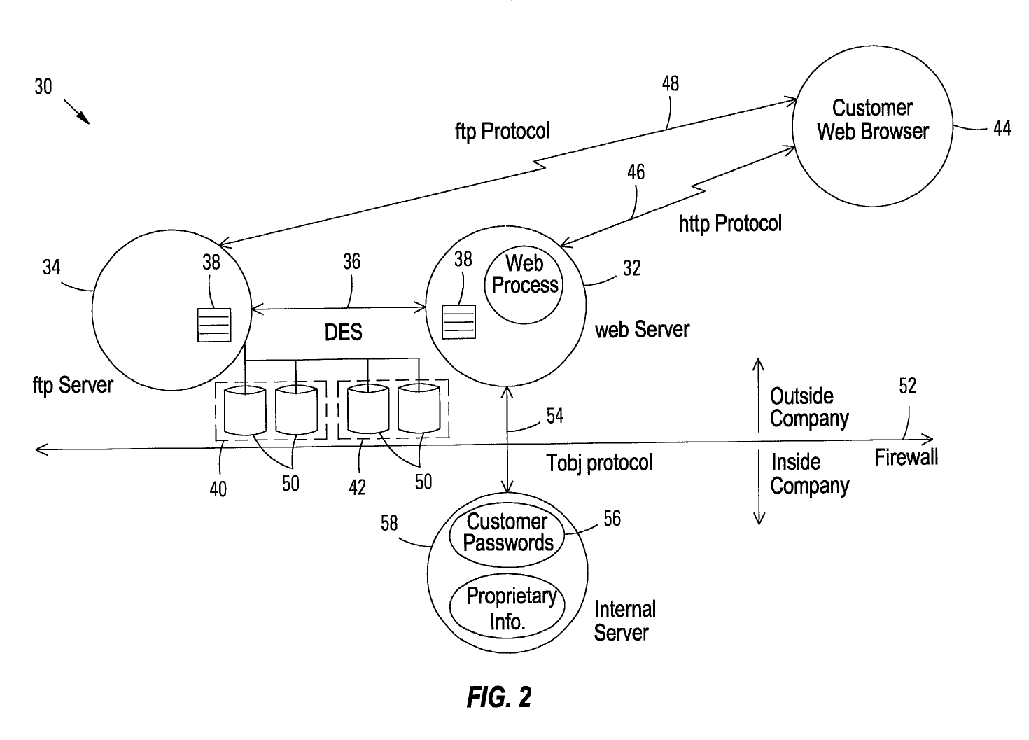

FIG. 2 shows a server configuration 30 of the present invention. A host machine 32 is used to handle web server processes. A separate host machine 34 is used to handle ftp server processes. A customer web browser 44 communicates via a communication link 46 (e.g modem or the like) with the web server 32 using http protocol (e.g. via an example URL http://destination). The customer web browser 44 also communicates with the ftp server 34 via a communication link 48 using ftp protocol (e.g. URL ftp://destination).

As separate machines 32, 34 are used for the two processes, a link 36 is needed for communicating between the two machines. Such a link includes, for instance, a LAN (local area network) connection. Data communicated over the LAN is done is a secure manner. The preferred embodiment uses a custom secure TCP protocol, henceforth referred to as the Fulfillment Server Protocol (FFS). This protocol is similar to the Network Virtual Terminal (NVT) protocol (i.e. RFC764, Telnet), in that it specifies a protocol for the exchange of arbitrary sized packets of ascii data, delimited by CR NL (carriage return, newline) boundary markers. However, the FFS Protocol enhances the generic NVT protocol by using DES encryption, applying a filter to render the cipher string 7-bit safe, and using a unique technique for securing passing the associated DES keys, wherein DES uses a known set of keys for encryption and decryption of data streams. The connection 36 between the two machines is therefore referred to as an FFS communications link (commlink) for discussion purposes.

Since the LAN connection between the two machines is potentially subject to filtering by an intruder, it becomes necessary to securely pass the recipient the key to decode the data stream (and to encode the reply). Before the web server and ftp server are first brought on line, the Daemon software is installed on them (daemons are processes that run in the background of a computer). The Daemon software implements the FFS commlink software which has compiled into it a finite set of N DES keys (e.g. a “bag” of keys) 38 which are retrievable by index number.

When one side of the FFS commlink receives an incoming FFS protocol packet, it selects one of the keys out if its bag of N keys 38 to decrypt the packet. The actual key itself is never sent across the LAN connection 36. Instead, it is assumed that the key will be contained within the bag of keys. The method used to select the proper key involves the following steps:

(1) Find the ephemeral port number, P, used for the connection. This port number varies, in a pseudorandom manner, per the implementation of the TCP specification.

(2) Compute the value I, where I=P modulo N.

(3) Use I as the index into the bag of keys, and use the DES key residing at index I to decrypt the request stream of data, and to encrypt the reply stream.

Notably, this is not a weakening of the DES key space. Even though there are only N keys (e.g. 128 keys), an intruder listening on the LAN connection 36 has no way of knowing which of the keys (e.g. potentially 2⁵⁶ keys) have been selected as the particular N keys for usage. Therefore an intruder cannot feasibly decode a packet in the FFS commlink, because the intruder has no idea about which DES key to use. Similarly, it is also virtually impossible to insert a fake packet in the FFS commlink stream, as the intruder does not know which key to use for the encryption. This is because no access has been provided to the bag of keys which were compiled into the code running at the two endpoint machines 32 and 34.

Another feature of the present invention enables the configuration to stage software for downloading relatively quickly (e.g. less than one second), regardless of the size of the software object. For instance, copying requires that the entire file be read from a safe area or storeroom 40, and then written into a customer account area 42. This might easily take tens of minutes on an unloaded system for a large file (e.g. 100 megabytes), and such transfer times might typically approach an hour or more on a busy system.

When an ftp download is staged for a customer, typically a chroot (change root) ftp account is created for that customer, and then the requested software is copied into that customer's ftp account. The chroot command limits a user's access to that particular directory level on the system. This provides security by preventing the customer from accessing arbitrary locations in the file system. It would be preferable to simply provide a symbolic link from the customer's ftp account 42 and the secure repository 40. However, due to the nature of the way the chroot command implements security, symbolic links cannot be properly resolved or utilized.

A solution exists in the characteristic implementation of certain file systems, such as HP-UX HFS (Hierarchical File System) and JFS (Journal File System), and particularly when implemented on a redundant array of independent disks 50 (raid). Because of the parallel structure of such raid file systems, and because of underlying features of the HP-UX file system, it is possible to create a hard link between the customer's ftp account area 42 and the secured repository area 40. This operation takes a trivial amount of time (typically less than one second), regardless of the size of the target file. Additionally, this technique provides the same relative degree of security as the conventional method of physically copying over the entire file. File space is saved since there is only one copy of the software object on the secured storage, rather than several duplicate copies existing in the various customer directories in storage area 42 (e.g. when two different customers request a download of the same object file).

Firewalls exist as hardware and software security measures in network configurations in order to prevent access to certain isolated machines or programs within the network or system. Prior systems have typically located customer authentication databases outside of a firewall 52, thus leaving proprietary customer access information vulnerable to external theft and attacks. The FFS architecture has eliminated the need for an external customer account database via use of an FFS secure commlink in conjunction with Tobj protocol. This allows data to cross the firewall 52 in a secure fashion from an internal master database 56 which resides on an internal machine or server 58.

Generally a system 30 should be designed with as few paths, or gateways, through the firewall 52 as possible. This protects proprietary information and the like 60 stored on the internal server 58. The present system uses the web server machine 32 as a proxy to communicate with the ftp server machine 34, and through the firewall 52, as necessary, in order to coordinate transfer of data. Additionally, there is no need to continually synchronize the internal database with an external database.

The server configuration(s) depicted and described above are not intended to be limited to the specific components or links shown, and such elements are only meant to illustrate the principles of the overall invention. It is to be understood that while certain forms of the invention are illustrated, they are not to be limited to the specific forms or arrangements of parts herein described and shown. It will be apparent to those skilled in the art that various changes may be made without departing from the scope of the invention and the invention is not to be considered limited to what is shown in the drawings and descriptions.

What is claimed is:

1. A method of facilitating the transfer of data to authorized users over the Internet, the method comprising:
(i) running a web server process on at least one host machine;
(ii) running an ftp server process on a separate host machine;
(iii) establishing a secure communication link between the host machines;
(iv) establishing at least one hard link between storeroom file storage areas and customer account file storage areas, the at least one hard link comprising a pointer to a file; and
(v) dynamically allocating customer access information from a secured database.

2. The method of claim 1, wherein said establishing a secure communication link comprises using a protocol for the exchange of arbitrary sized packets of ASCII data delimited by carriage return and newline boundary markers, and using DES encryption with N keys, said establishing a secure communication link comprising:
(a) finding the port number P used for the connection;
(b) computing an index value I, where I=P modulo N; and
(c) using the DES key residing at index I to encrypt and decrypt the data stream.

3. The method of claim 2, wherein the DES encryption creates a cipher string, further comprising filtering the cipher string.

4. The method of claim 1, further comprising issuing at least one change root command to limit access by the authorized users in the customer account file storage areas.

5. The method of claim 1, wherein the establishing at least one hard link between storeroom file storage areas and customer account file storage areas comprises creating a file pointer in the customer account file storage areas which points to a file in the storeroom file storage areas so that the file in the storeroom file storage areas can be accessed from the customer account file storage areas without copying the file to the customer account file storage areas.

6. The method of claim 1, further comprising said web server process receiving a request from one of said authorized users for at least one file.

7. The method of claim 6, further comprising said web server process determining whether to provide said at least one file by accessing a database on a host machine through a firewall.

8. The method of claim 1, further comprising said ftp server process allocating space on said customer account file storage areas for said at least one file.

9. The method of claim 8, further comprising creating a hard link on said space on said customer account file storage areas, said hard link pointing to said at least one file, wherein said at least one file resides in said storeroom file storage areas.

10. The method of claim 8, further comprising allowing at least one of said authorized users to access said space on said customer account file storage areas.

11. The method of claim 10, wherein the allowing at least one of said authorized users to access said space on said customer account file storage areas comprises issuing a change root command making said space a root directory for said at least one of said authorized users.
